(19) United States
(12) Patent Application Publication
(10) Pub. No.: US 2015/0061914 A1
(43) Pub. Date: Mar. 5, 2015

(54) RADIATION ATTENUATING CLOTHING

(71) Applicants: Robert Falken, Oceanside, CA (US); Steve Lake, Encinitas, CA (US)

(72) Inventors: Robert Falken, Oceanside, CA (US); Steve Lake, Encinitas, CA (US)

(21) Appl. No.: 14/525,151

(22) Filed: Oct. 27, 2014

Related U.S. Application Data
(63) Continuation-in-part of application No. 13/673,712, filed on Nov. 9, 2012.

(51) Int. Cl. H01Q 17/00; H01Q 15/14; A41D 27/20

(52) U.S. Cl. CPC H01Q 17/005; A41D 27/205; H01Q 15/14
USPC 342/1

(57) ABSTRACT

A pocket structure for a garment for a body of a wearer to reflect radio frequency radiation from a radiating device positioned therein. The pocket structure includes a first wall of fabric and a second wall of fabric, the first and second walls of fabric being attached along a major portion of their respective peripheral edges and forming an opening on a minor portion of their respective peripheral edges. The opening and the first and second walls of fabric forming an expandable compartment, each of the first wall of fabric and the second wall of fabric having an inner side facing the expandable compartment and an outer side, the opening being attached to the garment so as to position the second wall of fabric closer to the body of the wearer. The pocket structure further includes an electrically conductive material associated with the inner side of the second wall of fabric.

### CROSS REFERENCE TO RELATED APPLICATIONS

This application is a continuation-in-part of U.S. patent application Ser. No. 13/673,712, filed Nov. 9, 2012, entitled “Conventional Sewn-In Single Layer Garment Pocket With Electromagnetic Radiation Attenuation” the disclosure of which is hereby incorporated by reference in its entirety herein.

### BACKGROUND

The present invention relates generally to the field of electromagnetic radiation attenuating devices, and in particular to pockets for clothing for attenuation of electromagnetic radiation emissions from cellular telephones and other portable electronic devices carried therein.

Cellular telephone subscriptions are currently estimated at 5.9 billion globally and the use is expected to continue growing. Despite the fact that cellular telephones have been cited as a source of high amounts of electromagnetic radiation, people continue to use them, and carry them close to their body, such as in a pocket of a garment, etc. Electromagnetic radiation that is emitted from a cellular telephone carried by a user is generally directed towards the closest part of the user's body. This radiation is capable of causing some level of physical or reproductive harm to both men and women, especially after prolonged exposure. Some evidence has even linked cellular telephone electromagnetic radiation emissions to cancer. There is much debate in the media today about electromagnetic radiation possibly causing biological change and reproductive harm to humans. The link between radiation exposure and dose is not yet fully understood. However inconclusive the evidence is, there is reason enough for prudent avoidance

Proper shielding can help protect against electromagnetic radiation and the resulting health problems caused by over exposure to that radiation. In some conventional solutions, a housing, shell or encasement is affixed to, or fixedly receives, a cellular telephone to shield the local environment from electromagnetic radiation produced by the cellular telephone. However, these solutions will inhibit proper use of the cellular telephone by the housing, shell or encasement blocking radio frequency signals from being received by the cellular telephone.

### SUMMARY

This document describes electromagnetic radiation attenuating devices and methods of manufacture, related in particular to sewn-in pockets for cellular telephones and other portable electronic devices that produce electromagnetic radiation emissions. The sewn-in pocket permits storage and operation of the cellular telephone or other electronic device while instantaneously providing a convenient temporary shield from harmful electromagnetic radiation emissions.

In one aspect, a pocket structure for a garment for a body of a wearer to reflect radio frequency radiation from a radiating device positioned therein is described. The pocket structure includes a first wall of fabric and a second wall of fabric, the first and second walls of fabric being attached along a major portion of their respective peripheral edges and forming an opening on a minor portion of their respective peripheral edges. The opening and the first and second walls of fabric forming an expandable compartment, each of the first wall of fabric and the second wall of fabric having an inner side facing the expandable compartment and an outer side, the opening being attached to the garment so as to position the second wall of fabric closer to the body of the wearer. The pocket structure further includes an electrically conductive material associated with the inner side of the second wall of fabric, the electrically conductive material for reflecting the radio frequency radiation from the radiating device away from the body of the wearer when the radiating device is positioned within the expandable compartment of the pocket structure.

In another aspect, a garment is described. The garment can be a pair of pants, a pair of shorts, a shirt, a blouse, swimming trunks, a hat, or other garment. The garment includes a main body of fabric for being worn on a body of a wearer, and na pocket structure attached to the main body of fabric. The pocket structure is sized to receive a radiating device. The pocket structure includes a first wall of fabric and a second wall of fabric, the first and second walls of fabric being attached along a major portion of their respective peripheral edges and forming an opening on a minor portion of their respective peripheral edges. The opening and the first and second walls of fabric form an expandable compartment. Each of the first wall of fabric and the second wall of fabric have an inner side facing the expandable compartment and an outer side, the opening being attached to the garment so as to position the second wall of fabric closer to the body of the wearer. The pocket structure further includes an electrically conductive material associated with the second wall of fabric. The electrically conductive material reflects radio frequency radiation from the radiating device away from the body of the wearer when the radiating device is positioned within the expandable compartment of the pocket structure and is radiating the radio frequency radiation.

The details of one or more implementations are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a perspective view showing the outer side of the front side portion of a pair of pants including a conventional sewn-in single layer electromagnetic radiation attenuating pocket structure for a cellular telephone or other portable electronic device producing electromagnetic radiation emissions, with the pocket on the inside of the garment illustrated with phantom lines.

FIG. 2 is a cross sectional view taken along line 2-2 of the pocket structure shown in FIG. 1.

FIG. 3 shows the implementation of the pocket structure of the invention.

FIG. 4 shows an alternate implementation of the pocket structure of the invention.

FIG. 5 illustrates operation of the conventional sewn-in single layer pants pocket with electromagnetic radiation attenuation of the invention.

Like reference symbols in the various drawings indicate like elements.

### DETAILED DESCRIPTION

This document describes a pocket structure for garments for attenuating electromagnetic radiation. According to some implementations consistent with this disclosure, the pocket structure is described in the context of an electromagnetic radiation attenuating front pocket for pants, although those skilled in the art will recognize that the pocket structure may also be used in other areas of pants, or in numerous other garments such as shirts, shorts, skirts, blouses, or the like.

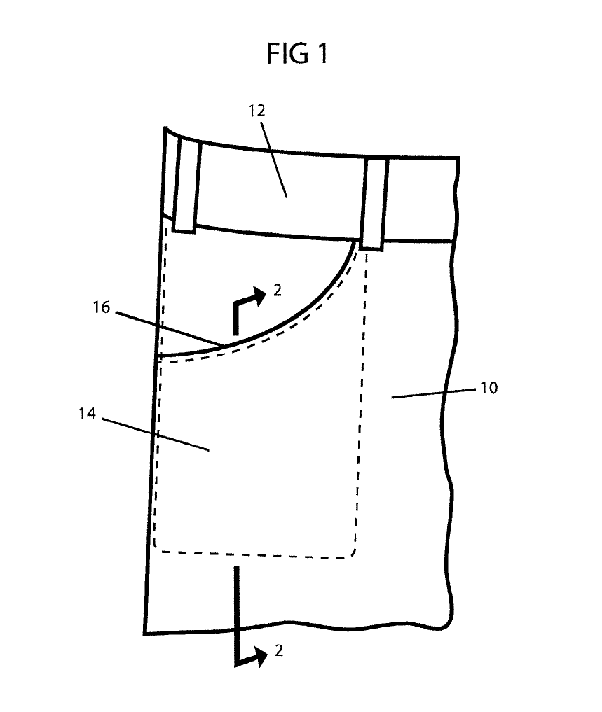

Referring first to FIG. 1, the outer side of the front side portion of a pair of pants is shown. The pants include a body 10 made of fabric. A waistband 12 of substantially conventional construction is included at the top of the garment. Connected with or hanging from the waistband is an electromagnetic radiation attenuating pocket structure 14 in accordance with implementations described herein. In some implementations, a pocket opening 16 through the pocket fabric provides access to the pocket.

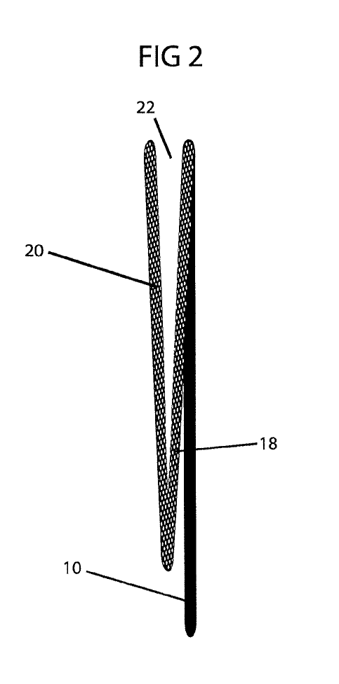

Referring to the cross-section shown in FIG. 2, the pocket structure 1 includes a single layer pocket that is formed of two opposed walls, pocket walls 18 and 20, of electromagnetic radiation attenuating fabric attached to each other along their edges to form an expandable compartment 22 between them. The pocket structure 1 is formed to hang on the inner side of the garment, adjacent the inner side of the garment fabric 10. The first pocket wall 18 is preferably adjacent and opposed to the inner side of the garment fabric. The first wall 18 can be referred to as an “outer” pocket wall and the second wall 20 can be referred to as an “inner” pocket wall.

The first and second pocket walls 18 and 20 may have essentially the same shape below the pocket opening 16. For the pants front pocket shown, the distance from the pocket opening 16 to the bottom of the pocket space 22 may be approximately 6.5 to 7.5 inches. The second wall 20 may have a total length of approximately ten inches to provide a sufficient amount of length to sew into the waistband 12. The first wall 18 may be 6.75 to 7.75 inches to extend to the pocket opening 16. The top edge of the first wall 18 may or may not be attached to the second wall 20. The first and second walls are preferably slightly wider than the pocket opening 16 so that the garment fabric 10 can be stitched to the first pocket wall 18 all around the fabric pocket opening 16.

For certain pockets, the first and second walls 18 and 20 may be formed of a single piece of electromagnetic radiation attenuating fabric folded on itself, i.e., approximately in half, and stitched along its free, non-folded edges, rather than two separate pieces of fabric.

According to some implementations, the walls 18 and 20 of electromagnetic radiation attenuating fabric can be formed of a shielding fabric such as STATICOT™ fabric, which is a polyester/cotton blend with microfine stainless steel fibers in a tough fabric similar to khaki In particular implementations, the electromagnetic radiation attenuating fabric is formed of a blend of about 34 percent polyester, about 41 percent combed cotton and about 25 percent high shielding metal fiber, which formation allows the electromagnetic radiation attenuating fabric to be washable, cuttable and sewable.

In alternative implementations, a fabric for the walls 18 and 20 of the electromagnetic radiation attenuating fabric include, by example and without limitation, a fabric such as Farabloc® which includes between about 2% and about 35% by weight of conductive fibers. Any suitably optimized fabric composition can be used, and can be based on a given situation to include such variables as radio frequency radiation strength, mode of operation of the mobile device, presence or absence of shielding case, etc.

In particular, the electromagnetic radiation attenuating fabric can incorporate conductive fibers (metal, carbon nanotubes, or other conductive fibers) of any suitable type to form a substantially continuous electrical conduction network in the fabric. The electrical conduction network can be formed in any suitable arrangement. The conductive fibers can be intermingled with non-conductive fibers to form the shielding fabric. Examples of suitable fibers include typical textile fibers, e.g., silk, wool, or other natural polyamide fibers; rayon, cotton, or other cellulosic fibers; or polyester, nylon, Kevlar, or other synthetic fibers. Alternatively, the conductive fibers can be applied to a surface of a non-conducting fabric to form the shielding fabric. In that latter case, the non-conducting fabric can comprise a woven or textile fabric. The conductive fibers can be combined with the non-conducting fabric in any suitable way, including those described above or others not explicitly disclosed herein, and all such combinations shall fall within the scope of the present disclosure.

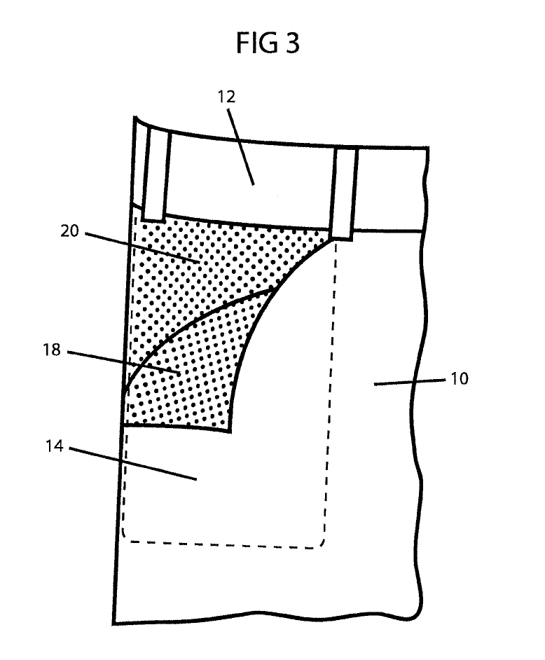

Referring now to FIG. 3, the implementation of the pocket structure of the invention includes a sewn-in single layer pants pocket that is formed of two opposed walls 18 and 20 wherein the “outer” pocket wall 18 is formed of electromagnetic attenuating fabric, and the “inner” pocket wall 20 is formed of electromagnetic attenuating fabric. As is typical, the pocket 14 hangs on the inner side of the garment.

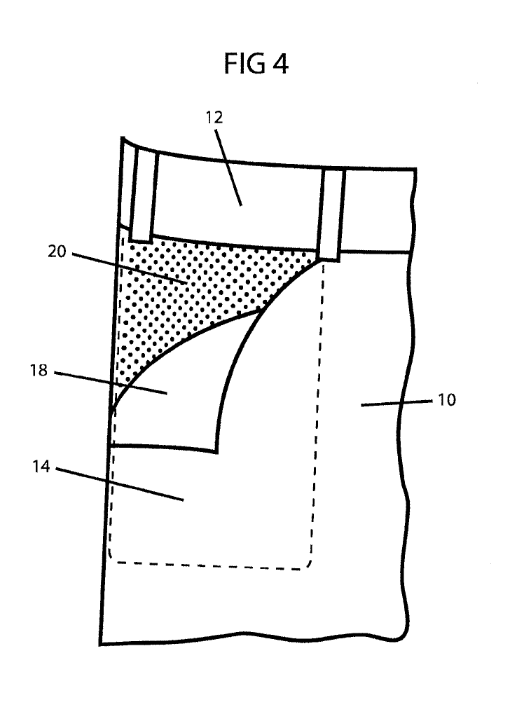

Referring now to FIG. 4, the alternate implementation of the pocket structure of the invention includes a sewn-in single layer pants pocket that is formed of two opposed walls 18 and 20 wherein the “outer” pocket wall 18 is formed of conventional fabric, and the “inner” pocket wall 20 is formed of electromagnetic attenuating fabric. As is typical, the pocket 14 hangs on the inner side of the garment.

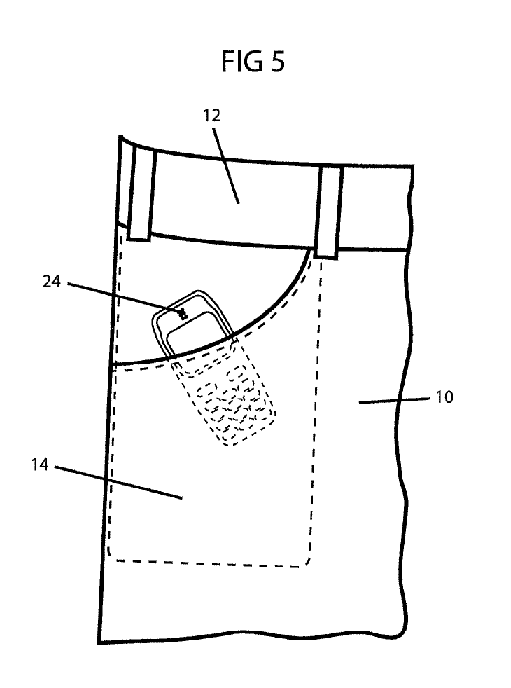

Referring now to FIG. 5, the operation of the conventional sewn-in single layer pants pocket with electromagnetic radiation attenuation is show by way of a cellular telephone 24 producing electromagnetic radiation emissions being placed within the pocket 14. The garment pocket structure described and shown is readily constructed and installed in conventional garments. No special waistband or major special garment structure needs to be constructed, thus the pocket structure is surprisingly easy and inexpensive to include in a finished garment.

As noted previously, although the garment pocket structure of the invention has been described by reference to implementations intended for use with pants, those skilled in the art will recognize that the electromagnetic radiation-attenuating pocket may also be used in coats, shorts, shirts, jackets, hats, undergarments, and other garments.

Conductive fabrics with electrical properties are made by blending or coating textiles with copper, stainless steel, nickel, and/or silver fibers. These conductive fabrics are are suited for electromagnetic shielding.

In some implementations, a conductive fabric is formed of: Face: 100% Silver Fiber/Backing: 100% Cotton, and has a thickness of about: 0.31 mm. In particular implementations, a conductive fabric has a yarn count of: (JC60S/2+70 Dag)×(JC60S/2+70 Dag); a density of 144×100; a weight of 164 g/m²; and a width of about 150 cm.

In other implementations, the conductive fabric is formed of 35% Tabinet/35% Cotton/30% Stainless Steel Fiber; and has a thickness of 0.2 mm. In particular implementations, the conductive fabric can have any of a yarn count of 32×32, a density of 100×70, a weight of 160 g/m², and/or a width of 150 cm.

Conductive fabrics can be formed of a non-conductive or less conductive substrate, which are plated with electrically conductive elements. In some implementations, pure silver, silver-plated or silver-coated fibers can be used to make fabrics that have silver on one side of the fabric. Adherence of the silver to the fabric can be provided in a number of ways and method. For example, in some implementations a single fabric is formed, with one side being coated or plated with silver, and the other side being left natural to expose a natural, non-metallic surface. The fabric can be electroplated using a battery or rectifier, which can be combined with a chemical solution to create the plating. When current is applied to the metallic component, it shifts the chemical composition, delivering a firm and removal-resistant coating to the surface of the fabric. Another method of adherence of silver to a fabric includes electroless plating, in which a chemical reduction process depends upon the catalytic reduction of a metallic ion in an aqueous solution containing a reducing agent, and the silver is subsequently deposited on the fabric without the use of electrical energy.

Electromagnetic shielding provided by the one side of the fabric provides protection by reducing radio frequency signals to levels at which they no longer affect equipment or can no longer be received. Reflecting and absorbing the radiation achieve this.

In alternative implementations, a textile fabric for pockets for clothing includes crossings between warp threads and weft threads, the threads being made of stainless steel fibers and textile fibers blended together and spun into mixed yarn, wherein the textile fibers include cotton fibers and are twined with the steel fibers. The steel fibers can include about 10% to 30% per weight of the mixed yarn and the distribution of the warp threads and the weft threads in the fabric and the composition of the warp threads and the weft threads being substantially the same. The higher the percentage of stainless-steel fibers by weight, the better the protection against the electromagnetic radiation exposure. However, a percentage of steel fibers above 30% per weight of the mixed yarn may result in comfort issues for the wearer of the clothing.

Although a few implementations have been described in detail above, other modifications are possible. Other implementations may be within the scope of the following claims.

1. A pocket structure for a garment for a body of a wearer to reflect radio frequency radiation from a radiating device positioned in the pocket structure, the pocket structure comprising:
a first wall of fabric and a second wall of fabric, the first and second walls of fabric being attached along a major portion of their respective peripheral edges and forming an opening on a minor portion of their respective peripheral edges, the opening and the first and second walls of fabric forming an expandable compartment, each of the first wall of fabric and the second wall of fabric having an inner side facing the expandable compartment and an outer side, the opening being attached to the garment so as to position the second wall of fabric closer to the body of the wearer; and
an electrically conductive material associated with the inner side of the second wall of fabric, the electrically conductive material for reflecting the radio frequency radiation from the radiating device away from the body of the wearer when the radiating device is positioned within the expandable compartment of the pocket structure.

2. The pocket structure in accordance with claim 1, wherein the electrically conductive material includes silver.

3. The pocket structure in accordance with claim 1, wherein the electrically conductive material is provided as a fiber that is intertwined with a textile to form the second wall of fabric.

4. The pocket structure in accordance with claim 1, wherein the electrically conductive material is deposited on the inner side of the second wall of fabric prior to attachment of the second wall of fabric with the first wall of fabric.

5. The pocket structure in accordance with claim 4, wherein the electrical conductive material is silver that is electroplated on the inner side of the second wall of fabric.

6. A pocket structure for a garment for a body of a wearer to reflect radio frequency radiation from a radiating device positioned in the pocket structure, the pocket structure comprising:
a first wall of fabric and a second wall of fabric, the first and second walls of fabric being attached along a major portion of their respective peripheral edges and forming an opening on a minor portion of their respective peripheral edges, the opening and the first and second walls of fabric forming an expandable compartment, each of the first wall of fabric and the second wall of fabric having an inner side facing the expandable compartment and an outer side, the opening being attached to the garment so as to position the second wall of fabric closer to the body of the wearer; and
an electrically conductive material associated with the second wall of fabric, the electrically conductive material reflecting the radio frequency radiation from the radiating device away from the body of the wearer when the radiating device is positioned within the expandable compartment of the pocket structure and is radiating the radio frequency radiation.

7. The pocket structure in accordance with claim 6, wherein the electrically conductive material includes silver.

8. The pocket structure in accordance with claim 6, wherein the electrically conductive material is provided as a fiber that is intertwined with a textile to form the second wall of fabric.

9. The pocket structure in accordance with claim 6, wherein the electrically conductive material is deposited on the inner side of the second wall of fabric prior to attachment of the second wall of fabric with the first wall of fabric.

10. The pocket structure in accordance with claim 9, wherein the electrical conductive material is silver that is electroplated on the inner side of the second wall of fabric.

11. A garment comprising:
a main body of fabric for being worn on a body of a wearer; and
a pocket structure attached to the main body of fabric, the pocket structure being sized to receive a radiating device, the pocket structure comprising:
a first wall of fabric and a second wall of fabric, the first and second walls of fabric being attached along a major portion of their respective peripheral edges and forming an opening on a minor portion of their respective peripheral edges, the opening and the first and second walls of fabric forming an expandable compartment, each of the first wall of fabric and the second wall of fabric having an inner side facing the expandable compartment and an outer side, the opening being attached to the garment so as to position the second wall of fabric closer to the body of the wearer; and
an electrically conductive material associated with the second wall of fabric, the electrically conductive material reflecting radio frequency radiation from the radiating device away from the body of the wearer when the radiating device is positioned within the expandable compartment of the pocket structure and is radiating the radio frequency radiation.
